(19) United States
(12) Patent Application Publication
(10) Pub. No.: US 2025/0338797 A1
(43) Pub. Date: Nov. 6, 2025

(54) VEHICLE WITH MOTOR IMBALANCE MONITORING

(71) Applicant: Textron Inc., Providence, RI (US)

(72) Inventors: William Christopher Dickson, Stowmarket (GB); Logan Bowman, Evans, GA (US); Lance Fielder, Providence, RI (US); Shayne Evan Rimer, North Augusta, SC (US); Leon Rodrigues, Providence, RI (US)

(73) Assignee: Textron Inc., Providence, RI (US)

(21) Appl. No.: 18/763,575

(22) Filed: Jul. 3, 2024

Related U.S. Application Data
(60) Provisional application No. 63/642,624, filed on May 3, 2024.

(51) Int. Cl. A01D 69/02; A01D 34/43; A01D 34/58; A01D 34/64; A01D 34/78; A01D 101/00

(52) U.S. Cl. CPC A01D 69/02; A01D 34/43; A01D 34/58; A01D 34/64; A01D 34/78; A01D 2101/00

(57) ABSTRACT

A mower system includes a mower and at least one processing circuit. The mower includes a chassis, a tractive element coupled to the chassis, a mower deck including a housing coupled to the chassis and a cutting element rotatably coupled to the housing, a first actuator coupled to the chassis, a first sensor configured to provide first sensor data related to operation of the first actuator, a second actuator coupled to the chassis, and a second sensor configured to provide second sensor data related to operation of the second actuator. The at least one processing circuit is configured to receive the first sensor data and the second sensor data, compare the first sensor data and the second sensor data, and provide a notification indicating a failure associated with the first actuator in response to a determination that the first sensor data differs from the second sensor data.

### CROSS-REFERENCE TO RELATED PATENT APPLICATION

This application claims the benefit of and priority to U.S. Provisional Application No. 63/642,624, filed on May 3, 2024, the entire disclosure of which is hereby incorporated by reference herein.

### BACKGROUND

The present disclosure relates generally to vehicles. More specifically, the present disclosure relates to outdoor equipment, such as mowers or golf cars.

Mowers are used to maintain vegetation (e.g., grass, clover, weeds, etc.) at a desired height. Mowers may include various motors for propulsion and/or operation of various implements. Over time, the motors may experience wear and require maintenance.

### SUMMARY

At least one embodiment relates to a mower system including a mower and at least one processing circuit having at least one processor and at least one memory. The mower includes a chassis, a tractive element coupled to the chassis, a mower deck including a housing coupled to the chassis and a cutting element rotatably coupled to the housing, a first actuator coupled to the chassis, a first sensor configured to provide first sensor data related to operation of the first actuator, a second actuator coupled to the chassis, and a second sensor configured to provide second sensor data related to operation of the second actuator. The at least one processing circuit is configured to receive the first sensor data and the second sensor data, compare the first sensor data and the second sensor data, and provide a notification indicating a failure associated with the first actuator in response to a determination that the first sensor data differs from the second sensor data.

Another embodiment relates to mower system including a mower and at least one processing circuit having at least one processor and at least one memory. The mower includes a chassis, a tractive element coupled to the chassis, a first cutting element, a second cutting element, and a third cutting element coupled to the chassis, a first electric motor coupled to the chassis and configured to drive the first cutting element, a first sensor configured to provide first sensor data related to operation of the first electric motor, a second electric motor coupled to the chassis and configured to drive the second cutting element, a second sensor configured to provide second sensor data related to operation of the second electric motor, a third electric motor coupled to the chassis and configured to drive the third cutting element, and a third sensor configured to provide third sensor data related to operation of the third electric motor. The at least one processing circuit is configured to receive the first sensor data, the second sensor data, and the third sensor data, determine, based on the first sensor data, the second sensor data, and the third sensor data, that the first electric motor requires maintenance, and provide a notification to a user in response to a determination that the first electric motor requires maintenance.

Still another embodiment relates to a non-transitory computer readable medium including instructions stored thereon that, when processed by at least one processor, cause the at least one processor to perform operations including (a) receiving first sensor data indicating a condition of a first electric motor of a mower, the condition of the first electric motor including at least one of a speed of the first electric motor, a temperature of the first electric motor, a current supplied to the first electric motor, or a voltage supplied to the first electric motor, (b) receiving second sensor data indicating a condition of a second electric motor of the mower, the condition of the second electric motor including at least one of a speed of the second electric motor, a temperature of the second electric motor, a current supplied to the second electric motor, or a voltage supplied to the second electric motor, (c) analyzing the first sensor data and the second sensor data to determine whether the first condition differs from the condition of the second electric motor, and (d) providing a notification to a user indicating that the mower requires maintenance in response to a determination that the first condition differs from the condition of the second electric motor.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a perspective view of a vehicle, according to an exemplary embodiment.

FIG. 1B is a perspective view of a vehicle, according to another exemplary embodiment.

FIG. 2 is a schematic block diagram of the vehicle of FIG. 1A, according to an exemplary embodiment.

FIG. 3 is a is schematic block diagram of a site monitoring and control system including a plurality of the vehicles of FIG. 1A, according to an exemplary embodiment.

FIG. 4 is another schematic block diagram of the site monitoring and control system of FIG. 3.

FIG. 5 is a block diagram of a process for transmitting, analyzing, and responding to data, according to an exemplary embodiment.

FIG. 6 is a side view of a deck actuator for a vehicle, according to an exemplary embodiment.

FIG. 7 is a front view of a reel motor for a vehicle, according to an exemplary embodiment.

FIG. 8 is a perspective view of a rotary deck motor for a vehicle, according to an exemplary embodiment.

FIG. 9 is a side view of a wheel motor for a vehicle, according to an exemplary embodiment.

FIG. 10 is a top view of a motor controller for a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle system includes one or more mowers that include multiple electric motors. When functioning properly, electric motors responsible for vehicle propulsion, reel rotation, and deck blade rotation on electric turf care mowers provide for optimal vehicle performance including quality of cut. Large mowers may have multiple electric mowers that perform equivalent or similar functions. By way of example, there may be 3 traction motors responsible for propulsion, 3 deck motors responsible for rotation of cutting blades, and 5 reel motors responsible for rotation of cutting reels. Some types of motors may not be present on every mower (e.g., a mower may have only reel motors or only deck motors), but it is necessary to have multiple equivalent motors in each type present).

Properly functioning motors performing an equivalent or similar function should output similar temperature and root mean square (RMS) current measurements during all stages of operation, as the motors all experience similar external conditions. Sensors collect temperature, current, voltage, and speed from each motor, and the sensor data is transmitted to a central monitoring solution by a controller of the vehicle. These measurements are continuous compared to other measurements from equivalent motors on the vehicle. If a significant difference in temperature, current, voltage, or motor speed is observed between any of the equivalent motors, a maintenance alert is generated.

### Overall Vehicle

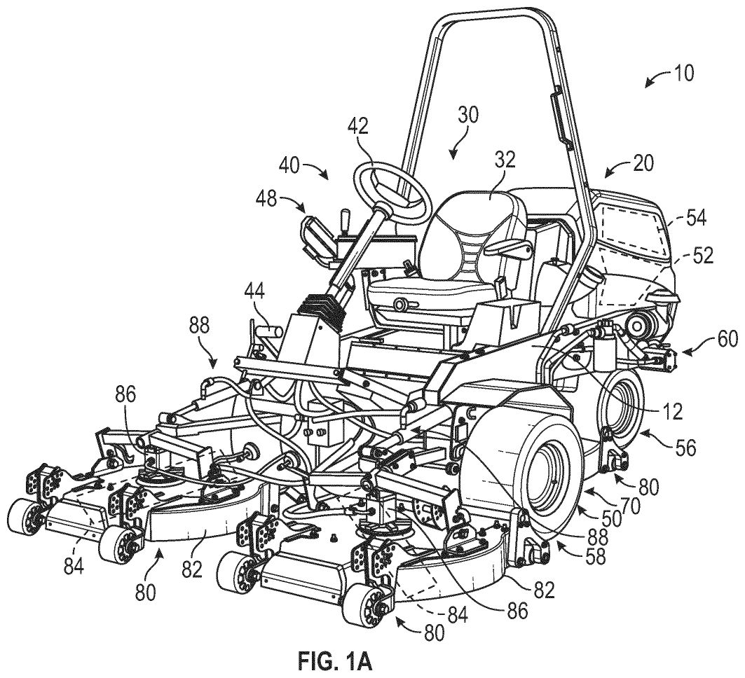

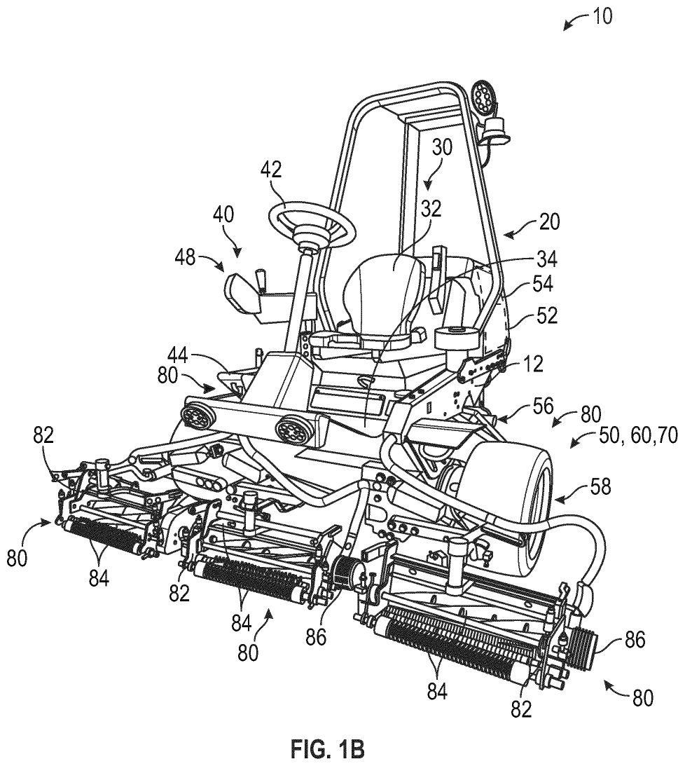

As shown in FIGS. 1A-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIGS. 1A and 1B, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIGS. 1A and 1B, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIGS. 1A and 1B, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

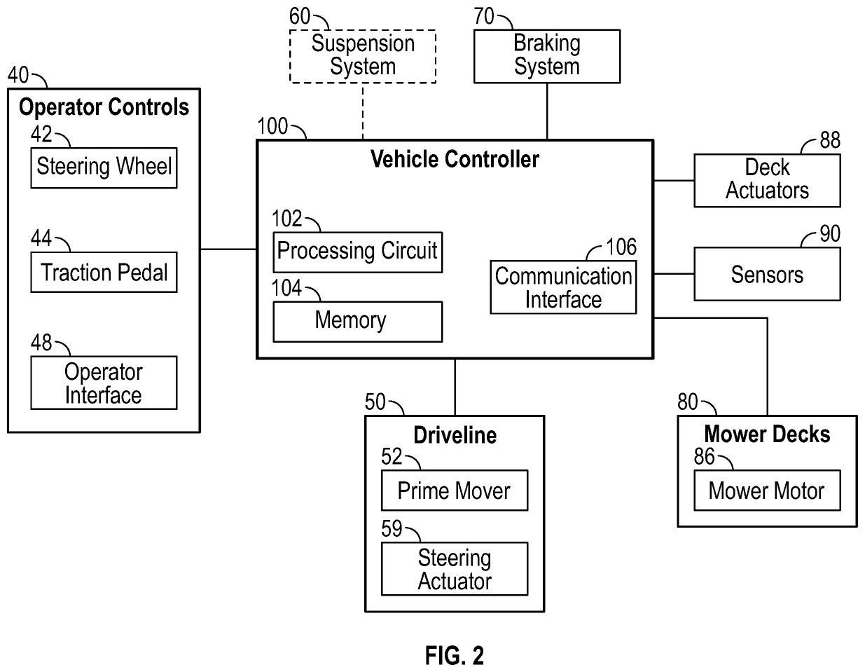

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1A, 1B, and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1A, 1B, and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIGS. 1A and 1B, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1A illustrates a vehicle 10 in which the mower decks 80 each include a cutting element 84 configured as a blade that rotates about a substantially vertical axis. FIG. 1B illustrates an alternative configuration in which the cutting elements 84 are configured as reels that each rotate about a substantially horizontal axis. Except as otherwise specified, the vehicle 10 of FIG. 1A may be substantially similar to the vehicle 10 of FIG. 1B. Accordingly, any description of the vehicle 10 of FIG. 1A may apply to the vehicle 10 of FIG. 1B, except as otherwise specified.

Referring to FIGS. 1A and 1B, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, the user sensors 220, the user portal 230, the remote systems 240, etc.). By way of example, the communications interface 130 may be configured to employ one or more types of wireless communications protocols including Bluetooth, Wi-Fi, radio, cellular, and/or other suitable wireless communications protocols.

### Site Monitoring and Control System

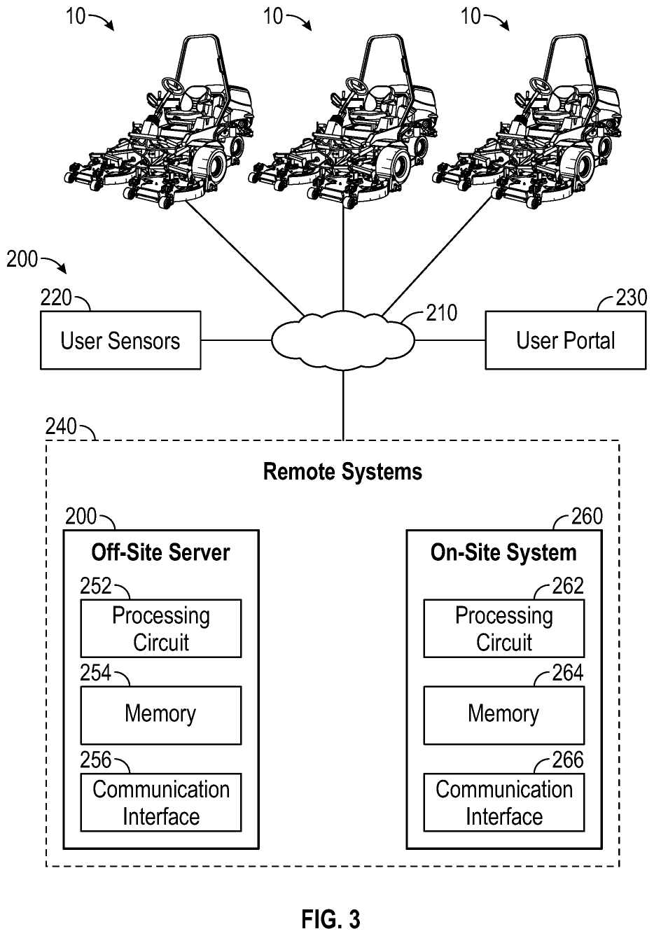

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Motor Imbalance Monitoring

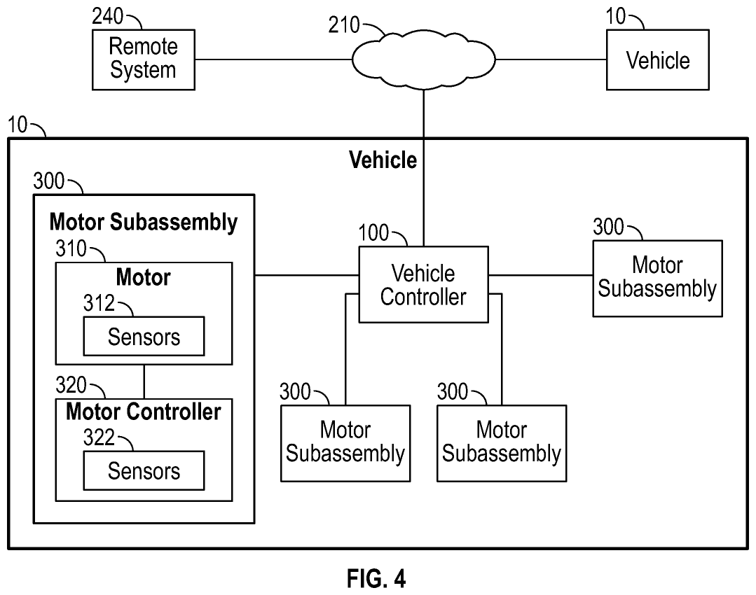

Referring to FIG. 4, the vehicle 10 includes a series of functional subassemblies (e.g., actuator assemblies, drive assemblies, etc.), shown as motor subassemblies 300. As shown, the vehicle 10 includes four motor subassemblies 300. In other embodiments, the vehicle 10 includes more or fewer motor subassemblies 300 (e.g., two, three, five, etc.). A detailed diagram of the one of the motor subassemblies 300 is shown for reference. However, it should be understood that the other motor subassemblies 300 may include similar components, arrangement, and/or functionalities.

Each motor subassembly 300 includes an electric motor, shown as motor 310. The motor 310 may be an alternating current (AC) electric motor or a direct current (DC) motor. In other embodiments, the motor 310 is another type of motor, such as a hydraulic or pneumatic motor. The motor 310 is configured to provide a mechanical energy output (e.g., a rotational mechanical energy output) to drive one or more functions of the vehicle. The motor 310 may drive a function of the vehicle 10 directly, through a power transmission (e.g., a gearbox or leadscrew, etc.), or through a hydraulic or pneumatic circuit (e.g., the motor 310 drives a pump that supplies pressurized fluid to an actuator).

The motor 310 may represent any of the motors or actuators described herein. In some embodiments, the motor 310 represents a prime mover 52 configured to drive a tractive element to propel the vehicle 10. By way of example, a vehicle 10 may include multiple electric motors that each drive a tractive element of the vehicle 10 to propel and/or steer the vehicle 10. In some embodiments, the motor 310 represents a portion of a deck actuator 88. By way of example, each deck actuator 88 of the vehicle 10 may include an electric motor that drives a screw to raise or lower a corresponding mower deck 80. The vehicle 10 may include multiple deck actuators 88 to control the height of each mower deck 80 individually. In some embodiments, the motor 310 represents an electric motor that drives one or more cutting elements 84 of a mower deck 80. The cutting element 84 may be a blade (e.g., as shown in FIG. 1A) or a reel (e.g., as shown in FIG. 1B). The vehicle 10 may include multiple motors 310 to accommodate multiple mower decks 80.

The motor 310 includes one or more sensors, shown as sensors 312. The sensors 312 may be coupled to or positioned within a housing of the motor 310. The sensors 312 may provide sensor data relating to operation of the motor 310. By way of example, the sensors 312 may include a temperature sensor (e.g., a thermocouple) that monitors a temperature of the motor 310. By way of another example, the sensors 312 may include a current sensor that monitors a current (e.g., RMS current) supplied to (e.g., passing into) the motor 310. By way of another example, the sensors 312 may include a voltage sensor that monitors a voltage supplied to (e.g., a voltage across) the motor 310. By way of another example, the sensors 312 may measure a speed (e.g., a rotational speed) of the motor 310.

The motor subassembly 300 further includes a controller, shown as motor controller 320, operatively coupled to the motor 310 (e.g., through a CAN bus). The motor controllers 320 may be controlled by the vehicle controller 100. The motor controller 320 is configured to supply energy or power (e.g., AC electrical energy, DC electrical energy, etc.) to the motor 310 to control operation of the motor 310. By way of example, the motor controller 320 may direct electrical energy from a battery (e.g., the energy storage 54) to the motor 310. The motor controller 320 may vary the supplied energy to vary operation of the motor 310. By way of example, the motor controller 320 may vary the current, voltage, and/or frequency of electrical energy supplied to a motor 310 to vary the speed, torque, and/or power of the motor 310.

The motor controller 320 includes one or more sensors, shown as sensors 322. The sensors 322 may replace or supplement the sensors 312 included in the motor 310. The sensors 322 may be positioned external to (e.g., outside of) the motor 310. By way of example, the sensors 322 may be coupled to or positioned within a housing of the motor controller 320. The sensors 322 may provide sensor data relating to operation of the motor 310. By way of another example, the sensors 322 may include a current sensor that monitors a current supplied to (e.g., passing into) the motor 310. By way of another example, the sensors 322 may include a voltage sensor that monitors a voltage supplied to (e.g., a voltage across) the motor 310. By way of another example, the sensors 322 may measure a speed (e.g., a rotational speed) of the motor 310.

The sensors 312 and/or 322 may measure the temperature, the voltage, the current, and/or the motor speed directly or indirectly. By way of example, the speed may be measured directly using an encoder, such as an optical encoder or cosine encoder. By way of another example, the speed may be measured indirectly through another measure that is related to speed. For example, the sensors 312 may measure the back electromotive force (back EMF) of the motor 310, and a component of the system may utilize the measured back EMF to calculate the speed of the motor 310.

The motor subassemblies 300 are operatively coupled to the vehicle controller 100. Accordingly, the sensor data from the sensors 312 and the sensors 322 is collected by the vehicle controller 100. In some embodiments, the vehicle controller 100 transfers the collected sensor data to a remote system 240 (e.g., wirelessly, through a network 210, etc.) for further analysis remotely. Additionally or alternatively, the vehicle controller 100 may analyze the sensor data locally.

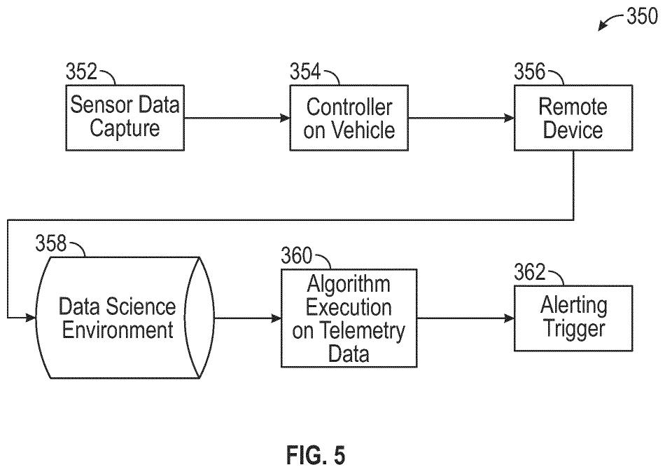

Referring to FIG. 5, a process 350 or method for transmitting, analyzing, and responding to data is shown according to an exemplary embodiment. In step 352, sensor data is captured. The sensor data may be provided by the sensors 312 and/or the sensors 322. By way of example, the motor controller 320 of each motor subassembly 300 may receive the sensor data.

In step 354, the received sensor data is transferred to the vehicle controller 100 (e.g., by the motor controller 320). Accordingly, the vehicle controller 100 may aggregate the sensor data from multiple motor subassemblies 300. The sensor data may include an identifier associating the sensor data with a specific motor 310 and/or a specific vehicle 10. The identifiers may be included in the sensor data when the sensor data is generated by the sensors 312 and 322. Alternatively, the identifiers may be added to the sensor data by the motor controller 320 and/or the vehicle controller 100.

In step 356, the vehicle controller 100 transfers the sensor data to the remote system 240. By way of example, the vehicle controller 100 may transfer the sensor data through the network 210. The remote system 240 may be in communication with multiple vehicles 10 through the network 210. In such an embodiment, the remote system 240 may receive sensor data from multiple different vehicles 10. In some embodiments, the vehicle controller 100 transfers the sensor data at predetermined, regular time periods. By way of example, the vehicle controller 100 may store all sensor data generated within a two minute period. At the end of the period, the vehicle controller 100 may send all of the stored sensor data to the remote system 240 (e.g., in a single file). After transmitting the sensor data, the sensor data may be deleted from the vehicle controller 100.

In step 358, the sensor data is stored in a database of the remote system 240. By way of example the database may be stored in the memory 254 of an off-site server 250 and/or the memory 264 of an on-site system 260. The database my store sensor data associated with multiple different vehicles 10 and/or multiple different motors 310. In such an embodiment, the identifiers may be utilized to identify the source of each set of sensor data.

In some embodiments, the remote system 240 determines an application type or function type of a motor 310 associated with the sensor data. By way of example, an association between each identifier and the corresponding function type may be predetermined and stored in the database. The function type of the motor 310 may indicate a category of function performed by the by motor 310. By way of example, the function type “cutting motor” may indicate that the motor 310 drives a cutting element 84. The function type may further specify whether the motor 310 drives a blade or a reel. In one example, the function type “blade motor” or “deck motor” indicates that the motor 310 drives a blade of a mower deck 80. In another example, the function type “reel motor” indicates that the motor 310 drives a reel of a mower deck 80. By way of another example, the function type “deck actuator” may indicate that the motor 310 drives a deck actuator 88 to raise and/or lower a mower deck 80. By way of another example, the function type “traction motor” may indicate that the motor 310 drives a tractive element to propel the vehicle 10.

In one embodiment, a vehicle 10 includes (a) five motors 310 identified as deck actuator motors that that control the height of mower decks 80, (b) three motors 310 identified as traction motors that drive tractive elements to propel the vehicle 10, (c) five motors 310 identified as reel motors that each drive a reel of a mower deck 80, and (d) three motors 310 identified as deck motors that each drive a blade of a mower deck 80.

In step 360, the sensor data is analyzed by the remote system 240 (e.g., by an off-site server 200 and/or an on-site system 260). Specifically, the sensor data is analyzed to identify a change in performance of a motor 310 indicative of a component that requires maintenance (e.g., a component that has failed, a component that is not operating optimally, etc.). The change in performance may be caused by a change in the motor 310 itself or a change in a component coupled to the motor 310.

During operation, multiple motors 310 having a common function type may be operated simultaneously. When motors 310 having a similar function type operate simultaneously, the motors 310 experience similar conditions (e.g., loads). Accordingly, the motors 310 may have similar power requirements and speeds and may increase in temperature at similar rates. By way of example, the vehicle 10 may operate all of the deck motors simultaneously to spin the blades. The blades are likely to experience similar resistances to rotation (e.g., due to cutting grass of similar heights, due to spinning freely in air, etc.) due to being positioned in close proximity to one another. Accordingly, during normal operation, the blade motors may maintain approximately the same speed, may draw approximately the same current, may rotate at approximately the same speed, and may be supplied with approximately the same voltage (e.g., may remain in balance with one other). If the temperature, current, speed, and/or voltage of a first one of the deck motors differs significantly from the corresponding values for the other deck motors (e.g., one of the motors is imbalanced), the difference may be indicative that the first one of the deck motors requires maintenance.

The remote system 240 may analyze the sensor data to identify a subset of the sensor data for multiple motors that (a) are associated with a particular vehicle 10 and (b) that have a common function type. By way of example, the remote system 240 may identify the sensor data for the motors 310 of a vehicle 10 that drive blades of mower decks 80 (i.e., the sensor data for the deck motors of a particular vehicle 10). Although the analysis is described herein with respect to the sensor data for the deck motors, a similar analysis would apply other motors 310 having a common function type.

After identifying the subset of the sensor data, the remote system 240 may analyze a portion of the identified sensor data corresponding to a given period of time to determine if the sensor data corresponding to one of the motors 310 differs significantly from the sensor data corresponding to the other motors 310. This analysis may be performed for each type of provided sensor data. By way of example, the analysis may be based on temperature, current, voltage, and/or motor speed. For example, if one of the motors 310 is significantly warmer or cooler than the other motors 310 performing a similar function, that motor is likely experiencing abnormal loading that requires maintenance intervention. If one of the motors 310 is drawing significantly more or less current than the other motors 310 performing a similar function, that motor is likely experiencing abnormal loading or an electrical fault. If one of the motors 310 is supplied with significantly more or less voltage than the other motors 310 performing a similar function, that motor is likely experiencing abnormal loading or an electrical fault. If one of the motors 310 is operating significantly faster or slower than the other motors 310 performing a similar function, that motor is likely experiencing abnormal loading.

In one embodiment, the remote system 240 compares the sensor data measured at a specific time. By way of example, the remote system 240 may calculate an average temperature of the deck motors at a specific time. Each temperature may be compared to the average, and a difference between the measured temperature and the average temperature may be calculated. If the magnitude of the difference exceeds a predetermined threshold (e.g., above or below the average), then the remote system 240 may determine that the corresponding motor 310 requires maintenance.

In one embodiment, the remote system 240 compares the sensor data over a period of time. By way of example, the remote system 240 may calculate a moving average of the sensor data for each motor. The moving average may be a moving average over a predetermined period of time (e.g., an average over the past 10 seconds, the past 2 minutes, the past hour, the past day, etc.). The remote system 240 may then calculate an overall average of the moving averages. Each calculated moving average may be compared to the overall average, and a difference between the calculated moving average for each motor and the overall average may be calculated. If the magnitude of the difference exceeds a predetermined threshold (e.g., above or below the overall average), then the remote system 240 may determine that the corresponding motor 310 requires maintenance.

In one embodiment, the remote system 240 compares the rate of change of the sensor data over a period of time. By way of example, the remote system 240 may calculate a derivate of the sensor data for each motor. The remote system 240 may then calculate an average rate of change of across the motors. Each calculated derivative may be compared to the overall average rate of change, and a difference between the calculated derivative for each motor and the average rate of change may be calculated. If the magnitude of the difference exceeds a predetermined threshold (e.g., above or below the overall average), then the remote system 240 may determine that the corresponding motor 310 requires maintenance.

In step 362, a notification or alert is provided to a user. The remote system 240 may provide the notification in response to a determination that a motor 310 requires maintenance. By way of example, the remote system 240 control a user device (e.g., a smartphone, a tablet, a laptop, a desktop computer, etc.) to provide the notification. The notification may take the form of a text message, an email, an auditory alert, a visual alert, or another type of notification. The notification may be provided to maintenance personnel associated with the vehicle 10 requiring the maintenance.

In other embodiments, some or all of the functions performed by the remote system 240 are instead performed locally by the vehicle controller 100. By way of example, step 356 may be omitted, and the vehicle controller 100 may perform steps 358, 360, and 362 locally. The notification of step 362 may be provided by a user interface of the vehicle 10, or the vehicle controller 100 may communicate with another user device (e.g., directly or through the network 210).

The notification may include information to facilitate the maintenance operation. By way of example, the notification may identify the vehicle 10 requiring the maintenance (e.g., a vehicle identification number). By way of example, the notification may identify the motor 310 requiring the maintenance. By way of example, the notification may indicate the function type of the motor 310 requiring the maintenance. By way of example, the notification may include a portion of the sensor data that triggered the maintenance request (e.g., a sample of the sensor data leading up to and/or surrounding when the sensor data began to differ from the other motors). Based on the notification, the user may identify the vehicle 10 and the motor 310 requiring maintenance.

Beneficially, the control system 200 facilitates early identification of poor component performance. Because the control system 200 compares the conditions of the motors to one another instead of comparing the condition of a specific motor to a predetermined threshold, the control system 200 is able to account for changes in environmental conditions (e.g., ambient temperature) and/or usage conditions (e.g., depth of cut) that are experienced by all of the motors simultaneously. The control system 200 automatically identifies components requiring maintenance and proactively notifies maintenance personnel of the issues. In other systems, such problems often linger until the lack of maintenance on the component causes an identifiable decrease in performance of the vehicle 10 (e.g., poor steering, inconsistent cutting, slow driving, etc.). By proactively notifying maintenance personnel as soon as an imbalance between the motors occurs, the degradation in performance is reduced or prevented.

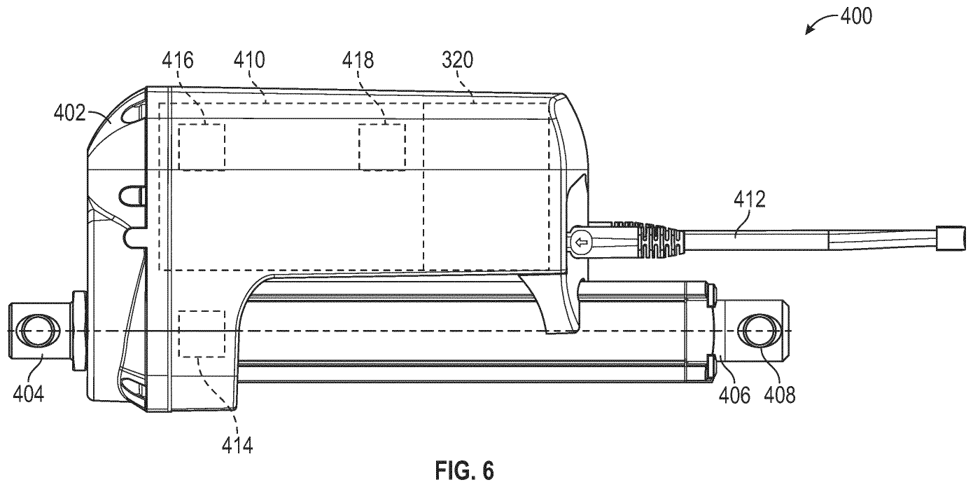

Referring to FIG. 6, an electric linear actuator is shown as deck actuator 400. The deck actuator 400 is an example of a motor 310 and may be used as (e.g., substituted for, an example of, etc.) a deck actuator 88. The deck actuator 400 includes a housing 402 defining a first interface 404 and a rod 406 defining a second interface 408. An electric motor 410 is coupled to the housing 402 and configured to move the rod 406 linearly (e.g., extend or retract the rod 406) relative to the housing 402 and change a distance between the first interface 404 and the second interface 408. The first interface 404 and the second interface 408 may each be coupled to one of (a) the frame 12 or (b) one or more of the mower decks 80. Accordingly, the electric motor 410 may raise or lower the one or more mower decks 80 by extending or retracting the rod 406.

Operation of the electric motor 410 is controlled by a motor controller 320 that is positioned within the housing 402. An electrical connector, shown as connector 412, transfers electrical energy and signals (e.g., data, commands, etc.) between the motor controller 320 and the vehicle controller 100 (e.g., through a CAN bus). The deck actuator 400 includes a series of sensors 312 operatively coupled to the motor controller 320 and configured to provide sensor data to the motor controller 320. A first sensor 312, shown as position sensor 414, provides sensor data indicating a position of the rod 406 relative to the housing 402 (e.g., a current extension length). The sensor data from the position sensor 414 may be used by the motor controller 320 to calculate a speed of the electric motor 410. A second sensor 312, shown as temperature sensor 416, provides sensor data indicating a temperature of the electric motor 410. A third sensor 312, shown as electrical sensor 418, provides sensor data indicating a voltage and/or a current supplied to the electric motor 410.

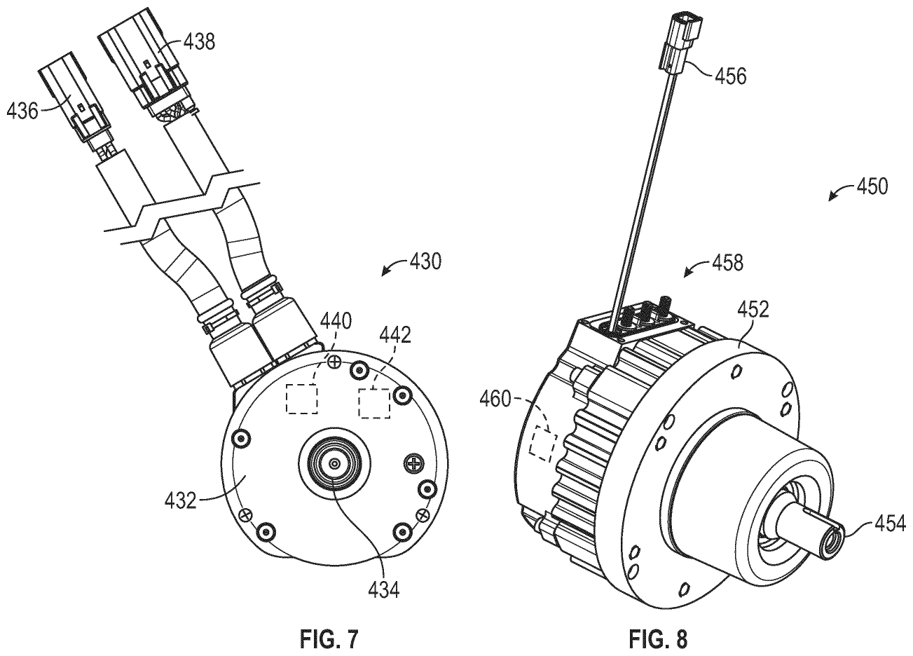

Referring to FIG. 7, an electric motor is shown as reel motor 430. The reel motor 430 is an example of a motor 310 and may be used as (e.g., substituted for, an example of, etc.) a mower motor 86. Specifically, the reel motor 430 may be configured to drive a cutting element 84 configured as a reel (e.g., as shown in FIG. 1B). The reel motor 430 includes a housing 432 and an output shaft 434. The housing 432 may be coupled to the housing 82 of a mower deck 80, and the output shaft 434 may be coupled to a cutting element 84. The reel motor 430 may drive rotation of the output shaft 434 to drive the cutting element 84.

Operation of the reel motor 430 is controlled by a motor controller 320 that is positioned outside of the housing 432. A first electrical connector, shown as connector 436, transfers electrical energy between the motor controller 320 and the reel motor 430. A second electrical connector, shown as connector 438, transfer signals (e.g., data, commands, etc.) between the motor controller 320 and the reel motor 430. The reel motor 430 includes a series of sensors 312 operatively coupled to the motor controller 320 and configured to provide sensor data to the motor controller 320. A first sensor 312, shown as speed sensor 440, provides sensor data indicating a speed of the output shaft 434. A second sensor 312, shown as temperature sensor 442, provides sensor data indicating a temperature of the reel motor 430. The motor controller 320 may include an electrical sensor that provides sensor data indicating a voltage and/or current supplied to the reel motor 430.

Referring to FIG. 8, an electric motor is shown as rotary deck motor 450. The rotary deck motor 450 is an example of a motor 310 and may be used as (e.g., substituted for, an example of, etc.) a mower motor 86. Specifically, the rotary deck motor 450 may be configured to drive a cutting element 84 configured as a blade (e.g., as shown in FIG. 1A). The rotary deck motor 450 includes a housing 452 and an output shaft 454. The housing 452 may be coupled to the housing 82 of a mower deck 80, and the output shaft 454 may be coupled to a cutting element 84. The rotary deck motor 450 may drive rotation of the output shaft 454 to drive the cutting element 84.

Operation of the rotary deck motor 450 is controlled by a motor controller 320 that is positioned outside of the housing 452. A first electrical connector, shown as connector 456, transfer signals (e.g., data, commands, etc.) between the motor controller 320 and the rotary deck motor 450. A second electrical connector, shown as connector 458, transfers electrical energy between the motor controller 320 and the rotary deck motor 450. The rotary deck motor 450 includes a series of sensors 312 operatively coupled to the motor controller 320 and configured to provide sensor data to the motor controller 320. A first sensor 312, shown as temperature sensor 460, provides sensor data indicating a temperature of the rotary deck motor 450. The motor controller 320 may include a sensor that provides sensor data indicating a back EMF produced by the rotary deck motor 450, and the motor controller 320 may calculate a speed of the output shaft 454 based on the sensor data. The motor controller 320 may include an electrical sensor that provides sensor data indicating a voltage and/or current supplied to the rotary deck motor 450.

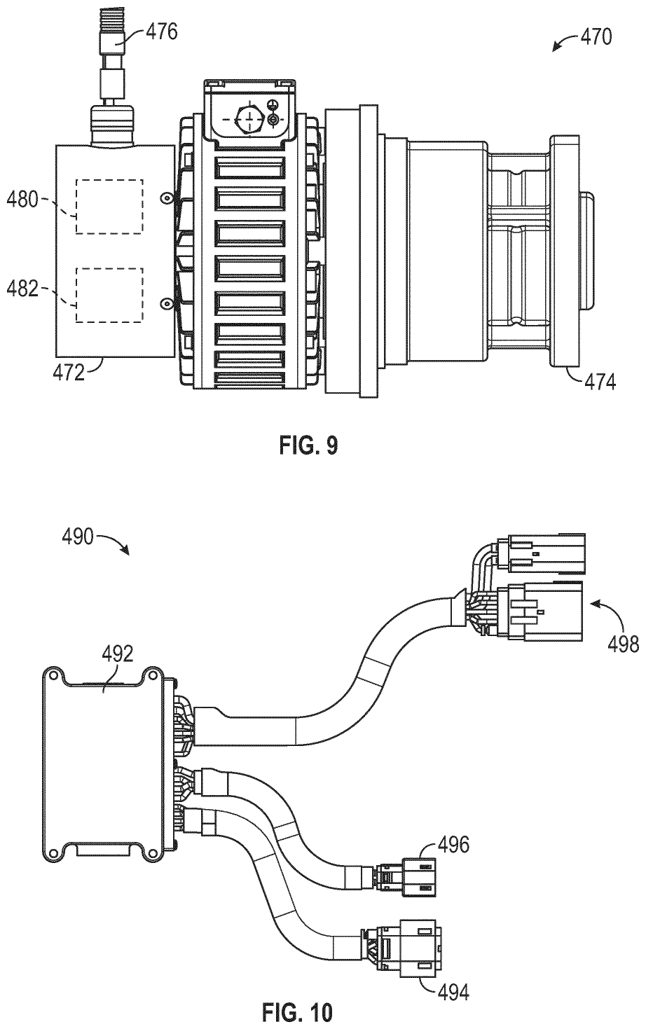

Referring to FIG. 9, an electric motor or drive motor is shown as wheel motor 470. The wheel motor 470 is an example of a motor 310 and may be used as (e.g., substituted for, an example of, etc.) a prime mover 52. Specifically, the wheel motor 470 may be configured to drive a wheel of the rear tractive assembly 56 or the front tractive assembly 58. In some embodiments, each wheel of the driveline 50 is driven by a corresponding wheel motor 470, such that the wheels are independently driven. The wheel motor 470 includes a housing 472 and an output portion 474. The housing 472 may be coupled to the frame 12, and the output portion 474 may be coupled to a wheel. The wheel motor 470 may drive rotation of the wheel to propel the vehicle 10.

Operation of the wheel motor 470 is controlled by a motor controller 320 that is positioned outside of the housing 472. An electrical connector, shown as connector 476, transfers electrical energy and signals (e.g., data, commands, etc.) between the motor controller 320 and the wheel motor 470. The wheel motor 470 includes a series of sensors 312 operatively coupled to the motor controller 320 and configured to provide sensor data to the motor controller 320. A first sensor 312, shown as speed sensor 480, provides sensor data indicating a speed of the output portion 474. A second sensor 312, shown as temperature sensor 482, provides sensor data indicating a temperature of the wheel motor 470. The motor controller 320 may include an electrical sensor that provides sensor data indicating a voltage and/or current supplied to the wheel motor 470.

Referring to FIG. 9, an electric motor or drive motor is shown as wheel motor 470. The wheel motor 470 is an example of a motor 310 and may be used as (e.g., substituted for, an example of, etc.) a prime mover 52. Specifically, the wheel motor 470 may be configured to drive a wheel of the front tractive assembly 56 or the rear tractive assembly 58. In some embodiments, each wheel of the driveline 50 is driven by a corresponding wheel motor 470, such that the wheels are independently driven. The wheel motor 470 includes a housing 472 and an output portion 474. The housing 472 may be coupled to the frame 12, and the output portion 474 may be coupled to a wheel. The wheel motor 470 may drive rotation of the wheel to propel the vehicle 10.

Referring to FIG. 10, a motor controller 490 shown according to an exemplary embodiment. The motor controller 490 may be an example of a motor controller 320. The motor controller 490 includes a body portion or housing, shown as housing 492, that contains processing circuitry and/or power electronics. A first electrical connector, shown as connector 494, transfer signals (e.g., data, commands, etc.) between the motor controller 490 and an electric motor (e.g., the reel motor 430, the rotary deck motor 450, the wheel motor 470, etc.). A second electrical connector, shown as connector 496, transfers electrical energy between the motor controller 490 and the electric motor. A third electrical connector, shown as connector 498, transfers electrical energy and signals between the motor controller 490 and the vehicle controller 100.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A mower system comprising:
a mower comprising:
a chassis;
a tractive element coupled to the chassis;
a mower deck including a housing coupled to the chassis and a cutting element rotatably coupled to the housing;
a first actuator coupled to the chassis;
a first sensor configured to provide first sensor data related to operation of the first actuator;
a second actuator coupled to the chassis; and
a second sensor configured to provide second sensor data related to operation of the second actuator; and
at least one processing circuit having at least one processor and at least one memory, the at least one processing circuit being configured to:
receive the first sensor data and the second sensor data;
compare the first sensor data and the second sensor data; and
provide a notification indicating a failure associated with the first actuator in response to a determination that the first sensor data differs from the second sensor data.

2. The mower system of claim 1, wherein the first actuator is a mower motor coupled to the housing of the mower deck and configured to drive the cutting element.

3. The mower system of claim 2, wherein the cutting element is a blade and the mower motor is configured to drive rotation of the blade about a substantially vertical axis.

4. The mower system of claim 2, wherein the cutting element is a reel and the mower motor is configured to drive rotation of the reel about a substantially horizontal axis.

5. The mower system of claim 2, wherein the mower deck is a first mower deck, the housing is a first housing, the cutting element is a first cutting element, and the mower motor is a first mower motor, wherein the mower further includes a second mower deck including a second housing coupled to the chassis and a second cutting element rotatably coupled to the second housing, and wherein the second actuator is a second mower motor coupled to the second housing of the second mower deck and configured to drive the second cutting element.

6. The mower system of claim 1, wherein the first actuator is a mower deck actuator coupled to the chassis and the mower deck and configured to raise the housing of the mower deck relative to the chassis.

7. The mower system of claim 1, wherein the first actuator is a drive motor coupled to the chassis and configured to drive the tractive element to propel the mower.

8. The mower system of claim 1, wherein the first actuator is a first electric motor and the second actuator is a second electric motor.

9. The mower system of claim 8, wherein the first sensor is a temperature sensor, and wherein the first sensor data indicates a temperature of the first electric motor.

10. The mower system of claim 8, wherein the first sensor data indicates at least one of (a) a current of electrical energy supplied to the first electric motor or (b) a voltage of the electrical energy supplied to the first electric motor.

11. The mower system of claim 8, wherein the first sensor data is related to a speed of the first electric motor.

12. The mower system of claim 11, wherein the first sensor data indicates a back electromotive force, and wherein the at least one processing circuit is configured to calculate the speed of the first electric motor based on the first sensor data.

13. The mower system of claim 1, wherein the mower further includes:
a third actuator coupled to the chassis; and
a third sensor configured to provide third sensor data related to operation of the third actuator,
wherein the at least one processing circuit is configured to provide the notification indicating the failure associated with the first actuator in response to a determination that the first sensor data differs from both the second sensor data and the third sensor data.

14. The mower system of claim 13, wherein the first actuator, the second actuator, and the third actuator all have a common function type.

15. The mower system of claim 1, wherein the at least one processing circuit includes a vehicle controller positioned onboard the mower and configured to:
receive the first sensor data and the second sensor data; and
compare the first sensor data and the second sensor data.

16. The mower system of claim 1, wherein the at least one processing circuit includes a server positioned remotely from the mower and configured to:
receive the first sensor data and the second sensor data;
compare the first sensor data and the second sensor data; and
provide the notification indicating the failure associated with the first actuator in response to the determination that the first sensor data differs from the second sensor data.

17. The mower system of claim 16, wherein the mower is a first mower, and wherein the server is configured to receive third sensor data from a second mower in communication with the server.

18. The mower system of claim 16, wherein the server is configured to control a user device to provide the notification.

19. A mower system comprising:
a mower comprising:
a chassis;
a tractive element coupled to the chassis;
a first cutting element, a second cutting element, and a third cutting element coupled to the chassis;
a first electric motor coupled to the chassis and configured to drive the first cutting element;
a first sensor configured to provide first sensor data related to operation of the first electric motor;
a second electric motor coupled to the chassis and configured to drive the second cutting element;
a second sensor configured to provide second sensor data related to operation of the second electric motor;
a third electric motor coupled to the chassis and configured to drive the third cutting element; and
a third sensor configured to provide third sensor data related to operation of the third electric motor; and
at least one processing circuit having at least one processor and at least one memory, the at least one processing circuit being configured to:
receive the first sensor data, the second sensor data, and the third sensor data;
determine, based on the first sensor data, the second sensor data, and the third sensor data, that the first electric motor requires maintenance; and
provide a notification to a user in response to a determination that the first electric motor requires maintenance.

20. A non-transitory computer readable medium including instructions stored thereon that, when processed by at least one processor, cause the at least one processor to perform operations comprising:
receiving first sensor data indicating a condition of a first electric motor of a mower, the condition of the first electric motor including at least one of a speed of the first electric motor, a temperature of the first electric motor, a current supplied to the first electric motor, or a voltage supplied to the first electric motor;
receiving second sensor data indicating a condition of a second electric motor of the mower, the condition of the second electric motor including at least one of a speed of the second electric motor, a temperature of the second electric motor, a current supplied to the second electric motor, or a voltage supplied to the second electric motor;
analyzing the first sensor data and the second sensor data to determine whether the condition of the first electric motor differs from the condition of the second electric motor; and
providing a notification to a user indicating that the mower requires maintenance in response to a determination that the condition of the first electric motor differs from the condition of the second electric motor.
